(19) United States
(12) Patent Application Publication
(10) Pub. No.: US 2005/0194540 A1
(43) Pub. Date: Sep. 8, 2005

(54) Methods and apparatus for small footprint imaging system

(76) Inventors: Paul Fenster, Petach Tikva (IL); Dov Kariv, Kfar Vradim (IL)

Correspondence Address: Dean D. Small;Armstrong Teasdale LLP, Suite 2600, One Metropolitan Square, St. Louis, MO, 63102, US

(21) Appl. No.: 10/795,827

(22) Filed: Mar. 8, 2004

(51) Int. Cl. G01T 1/166

(52) U.S. Cl. 250/363.05

(57) ABSTRACT

A method of imaging a patient is provided. The method includes coupling at least one detector to a detector transport member such that the at least one detector moves with the detector transport member and the detector transport member spans an arc of less than about one hundred eighty degrees about an examination axis, supporting the detector transport member through an arcuate base having an arcuate support assembly for receiving the detector transport member, and rotating the detector transport member about the examination axis to a plurality of imaging positions.

### BACKGROUND OF THE INVENTION

This invention relates generally to imaging systems, and more particularly to a movable imaging system detector support apparatus.

Imaging devices, such as gamma cameras and computed tomography (CT) imaging systems, are used in the medical field to detect radioactive emission events emanating from an object, and to detect transmission x-rays or transmission gamma rays attenuated by the object, respectively. An output, typically in the form of an image that graphically illustrates the distribution of the emissions within the object and/or the distribution of attenuation of the object is formed from these detections. An imaging device may have one or more detectors that detect the number of emissions, for example, gamma rays in the range of about seventy keV to about six hundred keV, and may have one or more detectors to detect x-rays and/or gamma rays that have passed through the object.

At least some known imaging systems include a closed ring gantry. To image a patient using a closed ring gantry, the patient ingresses and egresses the viewing area using a long travel bed that moves the patient longitudinally along an examination axis. However, such an ingress/egress configuration requires additional examining room floor space. This additional floor space is not usable during an imaging scan, but must be available during a scan to allow egress of the patient at the completion of the scan. A closed-ring gantry is also known to be less comfortable for the patient due to the claustrophobically close clearances of the gantry to the patient.

### BRIEF DESCRIPTION OF THE INVENTION

In one embodiment, a method of imaging a patient is provided. The method includes coupling at least one detector to a detector transport member such that the at least one detector moves with the detector transport member and the detector transport member spans an arc of less than about one hundred eighty degrees about an examination axis, supporting the detector transport member through a base having a support assembly for receiving the detector transport member, and rotating the detector transport member about the examination axis to a plurality of imaging positions.

In another embodiment, an imaging system for imaging a patient is provided. The system includes an arcuate detector transport member that extends circumferentially about an examination axis, an arcuate base that includes a support assembly for receiving the detector transport member, wherein the base is configured to rotate the arcuate detector transport member about the examination axis to at least one of a plurality of imaging positions, and at least one detector coupled to the detector transport member.

### BRIEF DESCRIPTION OF THE DRAWINGS

FIG. 1 is a side elevation view of an imaging system in accordance with one embodiment of the present invention;

FIG. 2 is a side elevation view of the imaging system in accordance with an another embodiment of the present invention; and

FIG. 3 is a perspective view of a portion of the imaging system shown in FIG. 2 taken across a section A-A shown in FIG. 2.

### DETAILED DESCRIPTION OF THE INVENTION

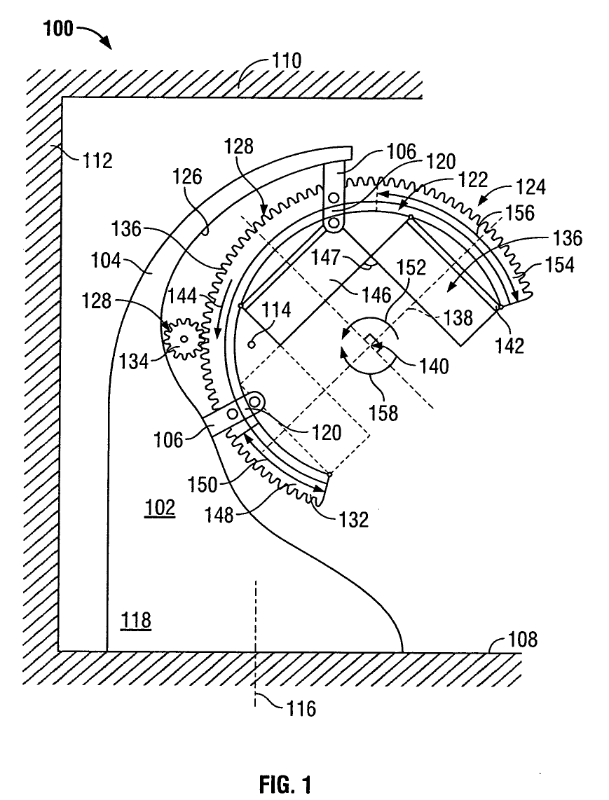

FIG. 1 is a side elevation view of an imaging system 100 in accordance with one exemplary embodiment of the present invention. Imaging system 100 includes a base 102 comprising a 104 and a support assembly 106. Base 102 may be configured to be fixedly coupled to, for example, a floor surface 108, ceiling 110, and/or a wall 112. Base 102 may be configured such that a center of gravity 114 (shown approximately located in FIG. 1) of imaging system 100 may be aligned with a centerline 116 of an attachment end 118 of body 104. Attachment end 118 may be coupled to floor 108 by, for example, welding, threaded fasteners, and/or clamping fasteners. Imaging system 100 may weigh several thousand pounds. In a configuration wherein imaging system 100 is coupled to wall 112, an additional support (not shown) may be used to further support base 102 from floor 108. In the exemplary embodiment, base 102 includes support assembly 106 having a sliding portion 120 configured to slidingly engage an edge 122 of a detector transport member 124, which is a generally arcuately-shaped member sized to extend circumferentially though a predetermined arc. In the exemplary embodiment, detector transport member 124 rotatably extends about one hundred eighty degrees. In an alternative embodiment, detector transport member 124 may rotatably extend less than one hundred eighty degrees, for example, about ninety degrees. Sliding portion 120 may be fabricated of a relatively long, arcuate surface spanning an arc along a radially inner portion 126 of body 104. Sliding portion 120 may include a plurality of relatively shorter segments, each spanning a relatively shorter arc along inner portion 126. To reduce friction between support assembly 120 and edge 122, support assembly may include a plurality of rolling elements that are configured to engage edge 122. Alternately, support assembly 120 may be configured such that edge 122 is coupled to inner portion 126 and sliding portion 120 may be coupled to detector transport member 124.

Base 102 also includes a power transmission assembly 128 for providing rotational force to detector transport member 124 from base 102. In the exemplary embodiment, power transmission assembly 128 is illustrated as a rack 130 coupled to a radially outer surface 132 of detector transport member 124, and a complementary pinion 134 rotatably coupled to base 102 such that pinion 134 engages rack 130. In an alternative embodiment, power transmission assembly 128 may be, for example, but not limited to, a belt or chain drive, a linear motor, and a fluid-actuated piston.

A detector 136 may be coupled to detector transport member 124 such that a detector centerline 138 of detector 136 is substantially orthogonally aligned with an examination axis 140 (illustrated as a “x”, indicating an orientation into and out of the page). Detector 136 may include a tilting base 142 configured to modify the alignment of centerline 138 with respect to examination axis 140. Detector 136 is coupled to detector transport member 124 such that detector 136 moves along an arcuate path 144 with detector transport member 124 and does not substantially move along path 144 with respect to detector transport member 124. Detector 136 may include radiation detectors constructed from, for example, scintillation materials such as sodium iodide or cesium iodide with associated photomultiplier tubes or other photo-detectors such as solid state photodiodes, radiation-sensitive scintillation material and a light detecting device, or may be fabricated from a semiconductor radiation detector including, for example, but not limited to, cadmium zinc telluride (CZT).

A second detector 146 may be employed in imaging system 100. Second detector 146 may be coupled to detector transport member 124 and may be spaced apart from detector 136 by a selectable angle 147 about examination axis 140. In the exemplary embodiment, angle 147 is about ninety degrees. In an alternative embodiment, angle 147 may be other than about ninety degrees. In the exemplary embodiment, both detectors 136 and 146 may be used for emission imaging and detector 136 may be simultaneously used for transmission imaging with a transmission x-ray source (not shown) or a transmission gamma source (not shown) positioned opposite detector 136 providing x-ray photons and/or transmission gamma rays at an energy level that may be different than the emission gamma energy levels. Detector 136 collects both emission gammas and transmission x-ray photons and/or transmission gamma rays, identifies the different photon energy levels and generates transmission data simultaneously. The two detector arrangement allows performing a scan of about one hundred eighty degrees about axis 140 while moving detectors 136 and 146 only through about ninety degrees of rotation about examination axis 140. The two detector arrangement also allows performing a scan of a region of a patient from two view angles simultaneously.

In operation, detector transport member 124 may begin a scan in a retracted position wherein a first end 148 of detector transport member 124 extends a distance 150 in a direction 152 relative to a fully extended position, wherein a second end 154 of detector transport member 124 extends a distance 156 in a direction 158 relative to the retracted position. In the extended position, detectors 136 and 146 are located approximately as shown by solid lines FIG. 1. In the retracted position detector 146 is shown in dotted lines, and detector 136 would occupy the illustrated location of detector 146.

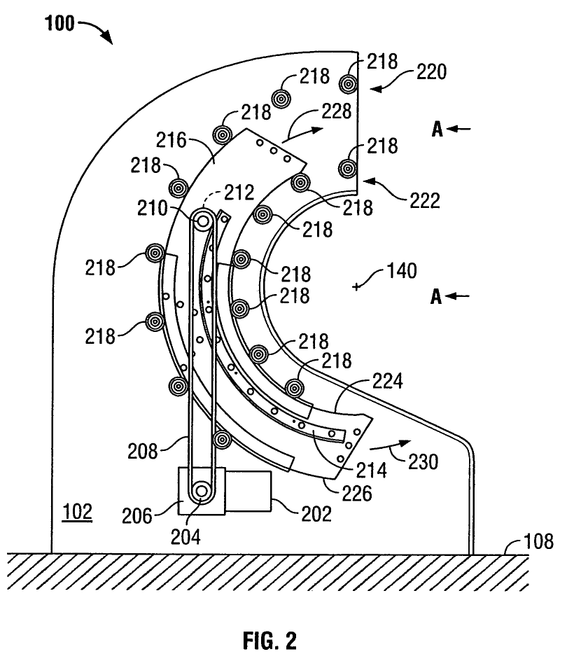

FIG. 2 is a side elevation view of imaging system 100 in accordance with an another exemplary embodiment of the present invention. Imaging system 100 includes base 102 that is configured to support imaging system 100 from floor surface 108, for example, by coupling base 102 to floor surface 108 or by simply resting base 102, such that system 100 is balanced and stable. Base 102 includes a motor 202 coupled to a pulley or sprocket 204 through a gear unit 206, for example, a reduction gear unit. Sprocket 204 transfers the rotational force of motor 202 to a toothed belt or chain 208 that in turn transfers a rotational force to a second sprocket 210 coupled to a pinion gear 212. In another embodiment, sprocket 204 is a pulley and chain 208 is a smooth belt. Pinion gear 212 is engaged with an arcuate rack 214 coupled to a detector transport member 216, thus forming a rack and pinion arrangement for transferring a rotational force to detector transport member 216. A plurality of support rollers 218 are arranged on base 102 in two concentric arcs, a first arc 220 arranged radially outward from a second arc 222. A first edge 224 and an opposite second edge 226 of detector transport member 216 are each configured to engage a circumferential groove (not shown in FIG. 2) in a periphery of support rollers 218.

During operation, motor 202 is supplied power through conduits (not shown), and is controlled by a control system (not shown) that is configured to energize motor 202 in a first or second direction to cause detector transport member 216 to rotate about examination axis 140 in an extend direction 228 or a retract direction 230. When power is not supplied to motor 202, a brake or other device maintain motor 202 and/or detector transport member 216 in a stationary position, for example, when collecting data at an imaging position. In another exemplary embodiment, movement of detector transport member 216 in extend direction 228 and/or retract direction 230 may be controlled through gear arrangements within gear unit 206.

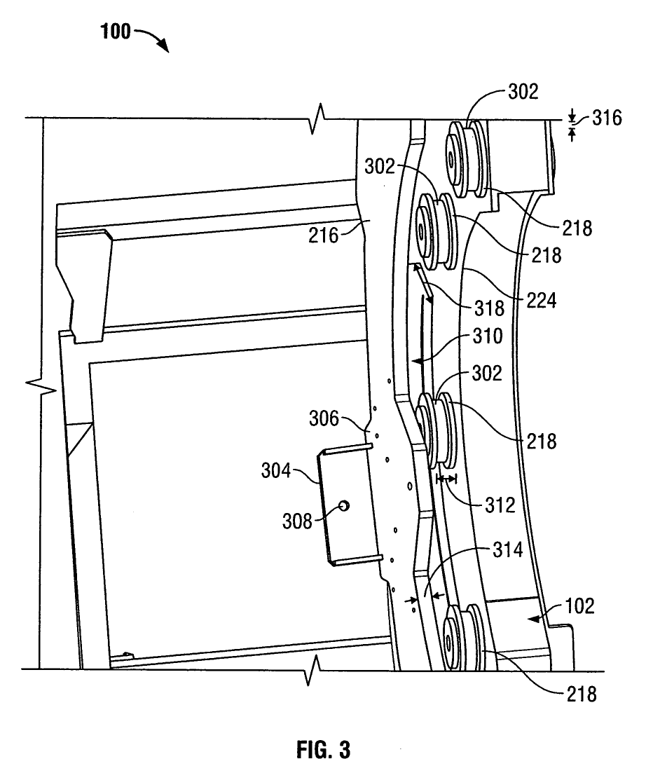

FIG. 3 is a perspective view of a portion of imaging system 100 (shown in FIG. 2) taken across a section A-A (shown in FIG. 2). Imaging system 100 includes base 102, detector transport member 216, rollers 218, and edge 224. In the exemplary embodiment, rollers 218 each include a circumferential groove 302 sized to receive edge 224. Detector transport member 216 includes a detector support flange 304 extending outwardly from a surface 306 of detector transport member 216. Detector support flange 304 facilitates coupling at least one detector (not shown) to detector transport member 216 and may include at least one aperture 308 sized to receive a mounting fastener (not shown). A detector coupled to surface 306 carries a significant amount of weight that is supported in cantilever fashion from rollers 218 by edge 224. The cantilevered load coupled through groove 302 tends to cause edge 224 to rotate in a direction 310 out of groove 302. Such moment load maybe compensated for by a width 312 of groove 302 and thickness 314 of edge 224, by a depth 316 of groove 302 and height 318 of edge 224, and/or by a predetermined circumferential spacing of rollers 218 along arcs 220 and 222.

The above-described embodiments of an imaging system provide a cost-effective and reliable means for examining a patient. More specifically, the imaging system includes a small floor space requirement by using an open gantry that allows patient ingress to and egress from an imaging system viewing area through a gap in the gantry. A detector transport member of the imaging system is moved away from a patient's ingress path by retracting the detector support member in telescoping fashion adjacent to an imaging system base.

Exemplary embodiments of imaging system methods and apparatus are described above in detail. The imaging system components illustrated are not limited to the specific embodiments described herein, but rather, components of each imaging system may be utilized independently and separately from other components described herein. For example, the imaging system components described above may also be used in combination with different imaging systems. A technical effect of the various embodiments of the systems and methods described herein include at least one of facilitating reducing imaging system siting requirements by reducing a floor space requirement of the imaging system.

While the invention has been described in terms of various specific embodiments, those skilled in the art will recognize that the invention can be practiced with modification within the spirit and scope of the claims.

1-45. (canceled)

46. A method of imaging a patient comprising:
coupling at least two nuclear medicine detectors to a detector transport member such that the at least two detectors move with the detector transport member, the detector transport member spanning an arc of less than about one hundred eighty degrees about an examination axis;
supporting the detector transport member with a base having a support assembly for receiving the detector transport member; and
rotating the detector transport member about the examination axis to a plurality of imaging positions.

47. A method of imaging a patient in accordance with claim 46 wherein coupling at least two detectors to a detector transport member comprises coupling a pair of nuclear medicine detectors together such that a detecting face of a first of the pair of nuclear medicine detectors is substantially perpendicular to a detecting face of a second of the pair of nuclear medicine detectors.

48. A method in accordance with claim 47 wherein coupling a pair of nuclear medicine detectors together comprises coupling a pair of nuclear medicine detectors together such that an edge of the detecting face of the first detector is proximate an edge of the second detector.

49. A method of imaging a patient in accordance with claim 46 wherein coupling at least two detectors to a detector transport member comprises coupling the at least two detectors to the detector transport member such that a normal centerline of a face of the at least two detectors is oriented substantially orthogonally to the examination axis.

50. A method of imaging a patient in accordance with claim 46 further comprising positioning a patient through a gap in the detector transport member where the patient is substantially aligned with the examination axis,

51. A method of imaging a patient in accordance with claim 46 wherein the detector transport member includes an edge and the base includes a support assembly having a groove and wherein supporting the detector transport member comprises engaging the groove with the edge such that the groove and edge oppose a moment load on the edge from the weight of the detector transport member.

52. A method of imaging a patient in accordance with claim 46 wherein the detector transport member includes a support assembly having a groove and the base includes an edge and wherein supporting the detector transport member comprises engaging the groove with the edge such that the groove and edge oppose a moment load on the groove from the weight of the detector transport member.

53. A method of imaging a patient in accordance with claim 46 wherein the detector transport member includes a rack and the base includes a complementary pinion and wherein rotating the detector transport member about the examination axis comprises controlling the rotation of an electrical motor coupled to the pinion to perform at least one of move the detector transport member between a plurality of imaging positions and maintaining the detector transport member substantially stationary at an imaging position.

54. A method of imaging a patient in accordance with claim 53 further comprising positioning the motor in the base.

55. A method of imaging a patient in accordance with claim 46 wherein rotating the detector transport member about the examination axis comprises rotating the detector transport member less than about one hundred eighty degrees while imaging the patient.

56. A method of imaging a patient in accordance with claim 55 wherein rotating the detector transport member about the examination axis comprises rotating the detector transport member about ninety degrees while imaging the patient.

57. A method of imaging a patient in accordance with claim 55 wherein rotating the detector transport member about the examination axis comprises rotating the detector transport member about ninety degrees while receiving images for an about one hundred eighty degree scan of the patient.

58. A method of imaging a patient in accordance with claim 46 further comprising receiving emission gamma rays using the at least two detectors.

59. A method of imaging a patient comprising:
aligning a patient with an examination axis by moving the patient through a gap in an arcuate detector transport member;
coupling a pair of nuclear medicine detectors together such that a detecting face of a first of the pair of nuclear medicine detectors is oriented substantially perpendicular with respect to a detecting face of a second detector of the pair;
rotating the pair of nuclear medicine detectors about the examination axis through an arc spanning less than about one hundred eighty degrees, the pair of nuclear medicine detectors moving with the detector transport member, said rotating comprises at least one of rotating the detector transport member intermittently between a plurality of imaging positions and rotating the detector transport member continuously from an imaging start position to an imaging finish position wherein the detector transport member spans an arc of less than about one hundred eighty degrees about the examination axis; and
supporting the detector transport member with a base having a support assembly for receiving the detector transport member, the base remaining stationary with respect to the examination axis.

60. A method in accordance with claim 59 wherein coupling a pair of nuclear medicine detectors together comprises coupling a pair of nuclear medicine detectors together such that an edge of the detecting face of the first detector is proximate an edge of the second detector.

61. A method in accordance with claim 59 wherein supporting the detector transport member comprises supporting the detector transport member with an arcuate base having an arcuate support assembly.

62. A method for medical imaging comprising:
translating a detector transport member along an arcuate path about an examination axis, the detector transport member spanning an arc of less than about one hundred eighty degrees about an examination axis, at least two detectors being coupled to said detector transport member; and
supporting the detector transport member with an arcuate base having an arcuate support assembly for receiving the detector transport member, the base remaining stationary with respect to the examination axis.

63. A method for medical imaging in accordance with claim 62 further comprising coupling a pair of nuclear medicine detectors together such that an edge of a detecting face of a first of the pair of nuclear medicine detectors is proximate an edge of a detecting face of a second of the pair of nuclear medicine detectors wherein the detecting faces are oriented substantially perpendicular with respect to each other.

64. A method for medical imaging in accordance with claim 62 wherein said rotating a detector transport member comprises at least one of rotating the detector transport member intermittently between a plurality of imaging positions and rotating the detector transport member continuously from a imaging start position to a imaging finish position.

65. A method for medical imaging in accordance with claim 64 wherein said rotating a detector transport member comprises rotating the detector transport member through an arc of less than about one hundred eighty degrees about the examination axis from the imaging start position to the imaging finish position.

66. An imaging system comprising:
an arcuate detector transport member that extends less than approximately 180 degrees circumferentially about an examination axis;
a base comprising a support assembly for receiving said detector transport member, said base configured to translate said arcuate detector transport member in an arcuate path about said examination axis to at least one of a plurality of imaging positions; and
at least two detectors coupled to said detector transport member.

67. An imaging system in accordance with claim 66 comprising an arcuate base having an arcuate support assembly.

68. An imaging system in accordance with claim 66 wherein said detector transport member is moveable along an arc defined by said base.

69. An imaging system in accordance with claim 66 wherein said detector transport member comprises a toothed rack configured to engage a pinion that is rotatably coupled to said base, said rack and said pinion configured to transmit a force from said base to said detector transport member that causes said detector transport member to move relative to said base.

70. An imaging system in accordance with claim 69 wherein said pinion is powered from an electric motor in the base.

71. An imaging system in accordance with claim 70 wherein said electric motor is powered from an electrical source located in said base.

72. An imaging system in accordance with claim 69 wherein said toothed rack is coupled to an outer periphery of said detector transport member.

73. An imaging system in accordance with claim 66 wherein said detector transport member comprises a sliding member configured to engage a support assembly coupled to said base, said sliding member configured to guide said detector transport member along an arcuate path.

74. An imaging system in accordance with claim 73 wherein said support assembly comprises a groove and wherein said sliding member comprises an edge, said edge configured to engage said groove.

75. An imaging system in accordance with claim 74 wherein said support assembly comprises a plurality of sliding segments, each sliding segment configured to engage said edge.

76. An imaging system in accordance with claim 74 wherein said support assembly comprises a plurality of rollers, each roller configured to engage said edge.

77. An imaging system in accordance with claim 73 wherein said support assembly is configured to support a moment load from a weight of said detector transport member.

78. An imaging system in accordance with claim 66 wherein said base is configured to rotate said detector transport member about said examination axis through an arc of less than about one hundred eighty degrees.

79. An imaging system in accordance with claim 78 wherein said arcuate base is configured to rotate said arcuate detector transport member about said examination axis through an arc of about ninety degrees.

80. An imaging system in accordance with claim 78 wherein said arcuate base is configured to rotate said arcuate detector transport member about said examination axis through an arc of less than about ninety degrees.

81. An imaging system in accordance with claim 66 wherein said arcuate base is configured to maintain said arcuate detector transport member substantially stationary relative to said arcuate base.

82. An imaging system in accordance with claim 81 wherein said arcuate base is configured to maintain said arcuate detector transport member substantially stationary while said at least two detectors are receiving emission gamma rays.

83. An imaging system in accordance with claim 66 wherein said at least two detectors are fixedly coupled to said detector transport member.

84. An imaging system in accordance with claim 66 wherein said at least two detectors are coupled to said detector transport member through a tilting mechanism configured to modify an orientation of said at least two detectors with respect to said examination axis.

85. An imaging system in accordance with claim 66 wherein said at least two detectors comprises cadmium zinc telluride (CZT).

86. An imaging system in accordance with claim 66 wherein said at least two detectors comprises pixilated cadmium zinc telluride (CZT).

87. An imaging system in accordance with claim 66 wherein said at least two detectors are configured to receive emission gamma rays at each of said at least one of a plurality of imaging positions, said emission gamma rays emitted from an imaging volume proximate said examination axis.

88. An imaging system in accordance with claim 84 wherein said at least two detectors are oriented at about ninety degrees with respect to each other.

89. An imaging system in accordance with claim 66 wherein said at least two detectors are configured to receive emission gamma rays at each of said at least one of a plurality of imaging positions, said emission gamma rays emitted from an imaging volume proximate said examination axis.

90. An imaging system in accordance with claim 66 wherein all said detectors are positioned at different fixed locations along said detector transport member.

91. A medical imaging apparatus comprising:
a generally arcuate shaped support assembly;
a detector transport member movably coupled to said generally arcuate shaped support assembly, the detector transport member spanning an arc of less than about one hundred eighty degrees about an examination axis; and
at least two detectors fixedly coupled to said detector transport member.

92. A medical imaging apparatus in accordance with claim 91 wherein said generally arcuate shaped support assembly comprises a generally C-shaped body.

93. A medical imaging apparatus in accordance with claim 91 wherein said detector transport member is generally arcuate shaped.

94. A medical imaging apparatus in accordance with claim 91 wherein said generally arcuate shaped support assembly is coupled to a base, said base comprising a power transmission member configured to move said detector transport member with respect to said base.

95. A medical imaging apparatus in accordance with claim 94 wherein said power transmission member receives power from an electric motor positioned in said base.

96. A medical imaging apparatus in accordance with claim 95 wherein said electric motor receives power from an electric source located in said base.
